(19) United States
(12) Patent Application Publication
(10) Pub. No.: US 2011/0054862 A1
(43) Pub. Date: Mar. 3, 2011

(54) Multimode Fiber Having Improved Reach

(75) Inventors: Richard J. Pimpinella, Frankfort, IL (US); Gaston E. Tudury, Lockport, IL (US)

(73) Assignee: PANDUIT CORP., Tinley Park, IL (US)

(21) Appl. No.: 12/873,901

(22) Filed: Sep. 1, 2010

Related U.S. Application Data
(60) Provisional application No. 61/239,229, filed on Sep. 2, 2009.

(51) Int. Cl. G06F 17/50; G02B 6/42

(52) U.S. Cl. 703/2; 385/28

(57) ABSTRACT

A means of improving the performance of laser optimized multimode fiber optic cable (MMF) to achieve improved optical margin and channel reach for use in high-speed data communication networks is described. The disclosed method can be used to improve the performance of both OM3 and OM4 grades of MMF.

### CROSS-REFERENCES TO RELATED APPLICATIONS

The present application claims the benefit of U.S. Provisional Patent Application No. 61/239,229, entitled “MULTIMODE FIBER HAVING IMPROVED REACH,” filed Sep. 2, 2009, the content of which is hereby incorporated herein in its entirety.

The present application incorporates in their entireties U.S. patent application Ser. No. 12/627,752, entitled “MULTIMODE FIBER HAVING IMPROVED INDEX PROFILE,” filed Nov. 30, 2009; U.S. patent application Ser. No. 12/797,328, entitled “DESIGN METHOD AND METRIC FOR SELECTING AND DESIGNING MULTIMODE FIBER FOR IMPROVED PERFORMANCE,” filed Jun. 9, 2010; U.S. patent application Ser. No. 12/858,210, entitled “SELF-COMPENSATING MULTIMODE FIBER,” filed Aug. 17, 2010; U.S. patent application Ser. No. 12/859,629, entitled “MODIFIED REFRACTIVE INDEX PROFILE FOR LOW-DISPERSION MULTIMODE FIBER,” filed Aug. 19, 2010; and U.S. patent application Ser. No. 12/869,501, entitled “METHODS FOR CALCULATING MULTIMODE FIBER SYSTEM BANDWIDTH AND MANUFACTURING IMPROVED MULTIMODE FIBER,” filed Aug. 26, 2010.

### BACKGROUND

To reduce the cost of next-generation optical transceivers for 8G/16G Fiber Channel and 40G/100G Ethernet, the optical and electrical transceiver specifications are being relaxed. As a result, the maximum channel reach for future Ethernet networks is planned to be reduced from 300 m on OM3 fiber as currently specified in 10 GBASE-SR (10 Gb/s Ethernet) to 125 m over high bandwidth laser optimized OM4 MMF (40G/100G Ethernet). However, channel length deployment data shows that a maximum reach of 125 m, within a data center, is not sufficient to support all the short-reach channel links traditionally provisioned with multimode fiber optic cable (MMF). Some data shows that more than 6% of the links will not be served with MMF, and therefore, more expensive alternative solutions such as single-mode optics or additional switch ports will be required.

Therefore a need exists for a high performance OM4 MMF that can support most, if not all, of the channel links within a data center utilizing next-generation low-cost optical transceivers.

### SUMMARY

In one aspect, a multimode fiber optic cable is provided. The multimode fiber optic cable includes, but is not limited to, a refractive index profile which is designed to compensate for a radially dependent wavelength distribution of laser launch modes coupled into the multimode fiber optic cable in order to minimize modal dispersion within the multimode fiber optic cable. The multimode fiber optic cable has a zero-dispersion slope of equal to or less than 0.10 ps/nm²·km.

In one aspect, a method for designing an improved multimode fiber optic cable having extended channel reach is provided. The method includes, but is not limited to, determining a radially dependent wavelength distribution for light emitted from a laser transmitter. The method also includes, but is not limited to, providing an improved refractive index profile for the improved multimode fiber optic cable which reduces modal dispersion within the improved multimode fiber optic cable based upon knowledge of the radially dependent wavelength distribution of light emitted from the laser transmitter.

The scope of the present invention is defined solely by the appended claims and is not affected by the statements within this summary.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 depicts a graph of a calculated margin for increased fiber bandwidth (EMB), in accordance with one embodiment of the present invention. As shown in FIG. 1, additional margin is gained going from OM3 (2000 MHz·km) to OM4 (4700 MHz·km), but little is gained in going to higher EMB values.

FIG. 2 depicts a graph of predicted channel reach for OM3 and OM4 fiber types, in accordance with one embodiment of the present invention. A maximum reach of 100 m and 125 m is achieved for OM3 and OM4 respectively given a maximum connector IL of 1.5 dB.

FIG. 3 depicts a graph of manufacturing data for a measured zero-dispersion slope in OM3 and OM4 MMF, in accordance with one embodiment of the present invention.

FIG. 4 depicts a graph of additional margin realized by reducing a dispersion slope of MMF, in accordance with one embodiment of the present invention. The IEEE Ethernet Link Model predicts a 0.18 dB increase in margin.

FIG. 5 depicts a graph of maximum channel reach as a function of total connector loss for OM4 MMF with a reduced zero-dispersion slope, in accordance with one embodiment of the present invention. OM4 MMF has an EMB of 5000 MHz·km. Reach is extended by 9.6% over standard optical fibers (for example, over standard optical fibers having a zero-dispersion slope of 0.105 ps/nm²km).

FIG. 6 depicts a graph of measured and theoretical attenuation curves for optical fiber showing that optical attenuation is close to the theoretical limit, in accordance with one embodiment of the present invention.

FIG. 7 depicts a graph of maximum channel reach as a function of total connector loss for OM4 MMF with a reduced optical attenuation coefficient, in accordance with one embodiment of the present invention. Reach of the OM4 MMF with a reduced optical attenuation coefficient is extended by more than 5% over standard cabled optical fibers (for example, over standard cabled optical fibers with attenuation coefficients of 3.5 dB/km) to nearly 145 m.

FIG. 8 depicts a graph of maximum channel reach as a function of total connector loss for improved-reach OM4 MMF, in accordance with one embodiment of the present invention. Total reach of the improved-reach OM4 MMF is extended by approximately 72% over standard optical fibers (for example, over standard optical fibers that do not compensate modal and chromatic dispersion) to 215 m for a total connector loss of 1.5 dB.

### DETAILED DESCRIPTION

The present invention makes use of the discovery that by providing an ultra-high performance improved OM4 MMF having improved optical characteristics, the improved OM4 MMF can support an extended channel reach beyond current OM4 MMF capability. This improved OM4 MMF can extend the maximum channel reach from 125 m to a distance closer to the theoretical limit of OM4 MMF of approximately 215 m (as determined by the IEEE Ethernet Link Model). In addition to improved optical characteristics, this improved OM4 MMF can compensate for the effects of chromatic dispersion between discrete fiber modes providing improved performance as well as transmission reliability. However, variations in the manufacturing process will continue to limit fiber bandwidth and therefore, a more practical reach objective might be somewhat less than 200 m. MMF manufactured in accordance with this invention will provide improved bandwidth-distance performance, offering a unique product opportunity for next-generation data center network connectivity.

It is believed that inter-modal dispersion will continue to dominate over chromatic dispersion in next-generation low-cost multimode optical systems, provided the Effective Modal Bandwidth (EMB) of the MMF is less than 6000 MHz·km. Some benefit may be derived by improving several other important parameters in order to achieve improved performance. In this disclosure, the improvement of these other parameters is described and the corresponding improvement in performance is quantified in terms of channel reach. The improvement of these other parameter provides additional reach capability.

The performance and reach of MMF is mostly limited by attenuation and total dispersion in the fiber. Attenuation is the optical loss per unit length due to both scattering and absorption within the fiber itself. Dispersion is the broadening of discrete data bits as they propagate through the fiber. Pulse broadening results in a smearing or overlap between sequential data bits causing an increase in the uncertainty whether a bit is a logic 0 or 1. This uncertainty in logic state is manifested in a channel's Bit Error Rate (BER), where the BER is defined as the number of error bits divided by the total number of bits transmitted in a given period of time.

There are two contributions to the total dispersion: chromatic dispersion and modal dispersion. Chromatic dispersion, also known as material dispersion, occurs because the refractive index of a material changes with the wavelength of light. Typically, with the materials and wavelengths conventionally used for MMF fiber optics, shorter wavelengths encounter a higher refractive index (i.e., greater optical density) and consequently travel slower than longer wavelengths. Since a pulse of light typically comprises several wavelengths, the spectral components of the optical signal spread in time, or disperse, as they propagate, causing the pulse width to broaden.

Due to the wave nature of light and the wave guiding properties of optical fiber, an optical signal propagates through the fiber in discrete optical paths called modes. Since the discrete modes have different path lengths, they arrive at the output of the fiber at different times. The difference in propagation delays between the fastest and slowest modes in the fiber is used to quantify the inter-modal dispersion or simply modal dispersion. MMF is typically designed so that all modes arrive at the output of the fiber at approximately the same time. This is achieved by adjusting or “grading” the refractive index profile of the fiber core (conventionally, in a parabolic distribution from the center to the outer edge of the core) so that modes traveling with greater angles with respect to the core axis (higher order modes) travel faster, and modes traveling with small angles (low-order modes) travel slower.

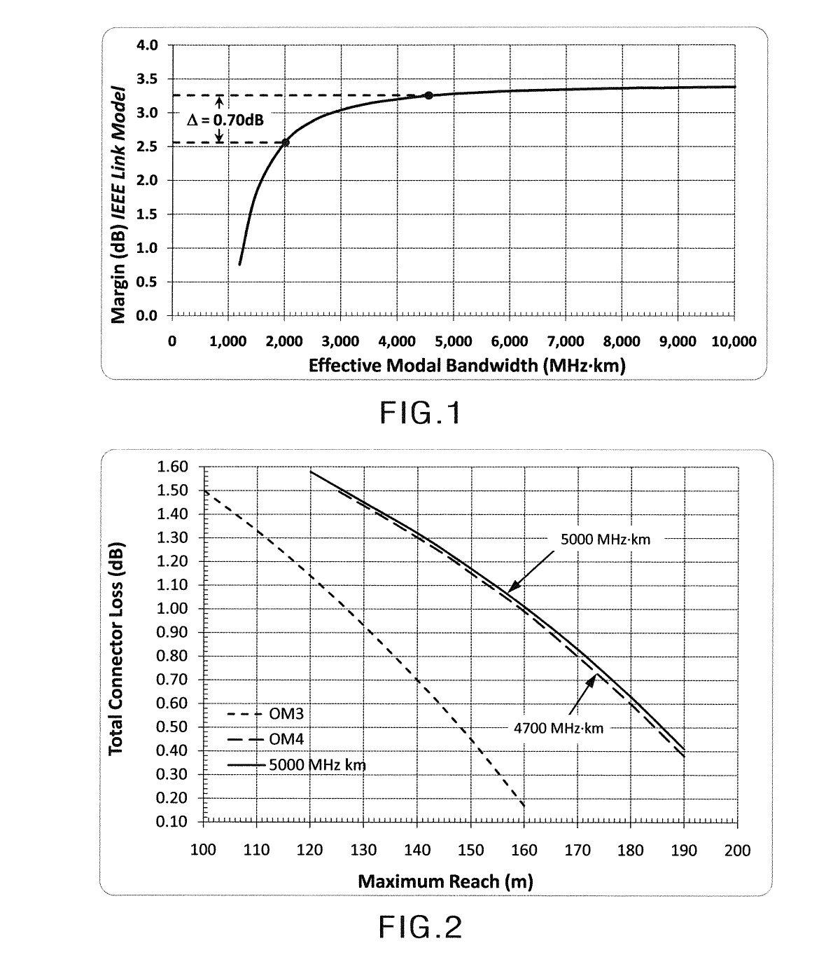

Reducing modal dispersion alone will not provide the performance improvement needed to achieve improved fiber reach as disclosed herein. Using the IEEE Ethernet link model, we plot the increase in optical margin as a function of Effective Modal Bandwidth (EMB), where EMB characterizes the bandwidth capability of a fiber expressed in units of megahertz kilometer (MHz·km), see FIG. 1. EMB is calculated from pulse waveform data obtained by a modal dispersion measurement (Differential Mode Delay) (See TIA-492AAAD, “Detail specification for 850-nm laser-optimized, 50-μm core diameter/125-μm cladding diameter class Ia graded-index multimode optical fibers suitable for manufacturing OM4 cabled optical fiber”). The minimum EMB for OM4 fiber is specified to be 4700 MHz·km. Our analysis shows (FIG. 1) that there is little margin gained by increasing the EMB beyond 4700 MHz·km. However, for improved-reach OM4, we propose a minimum EMB of 5000 MHz·km to guard against measurement variation and guarantee OM4 EMB compliance. For a maximum channel insertion loss (IL) of 1.5 dB as specified in 40G & 100G Ethernet, the predicted maximum channel reach for OM3 and OM4 fiber is 100 m and 125 m respectively, as shown in FIG. 2. We note that reducing channel IL provides additional reach; however in most cases this will not be a viable option since multifiber push-on (MPO) connector technology will be employed with multiple connector interfaces. Although a significant reduction in connector IL is unlikely and difficult to control, it is possible to reduce cable attenuation which will be discussed later.

With reference to Table 1, given an OM4 MMF with a specific EMB, in this case 5000 MHz·km, an improved-performance MMF can be realized by reducing two key optical parameters, chromatic dispersion and attenuation.

TABLE 1
OM4 Optical Specifications, TIA-492AAAD

| | Performance requirements |
|---|---|
| Attribute | & test conditions |
| Attenuation coefficent at | ≦2.5 dB/km |
| 850 nm | |
| Zero dispersion Wavelength | 1295 nm ≦ λ₀ ≦ 1320 nm |
| Zero-dispersion slope | ≦0.105 ps/nm² · km |
| | For 1300 nm ≦ λ₀ ≦ 1320 nm |

Reducing chromatic dispersion is one method for realizing an improved-performance MMF. Chromatic dispersion, D(λ), is quantified in terms of a zero-dispersion slope, S₀, determined from the wavelength-dependent propagation delay, defined as:

$$D ( λ ) = \frac{d}{d λ} τ ( λ ) = \frac{{S}_{0}}{4} λ ( 1 - \frac{{λ}_{0}^{4}}{{λ}^{4}} ) \qquad [ 1 ]$$

where, λ₀ is a zero-dispersion wavelength, as shown in Table 1.

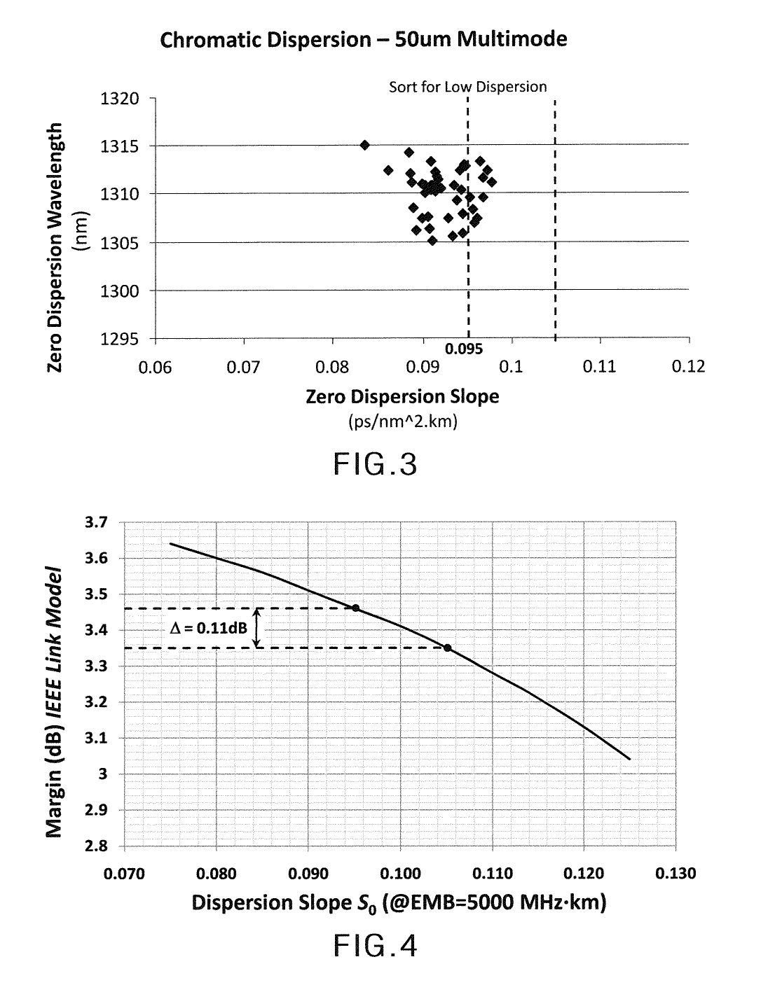

High-quality OM4 MMF made today typically has a zero-dispersion slope less than 0.105 ps/nm²·km as specified in TIA-492AAAD (See TIA-492AAAD, “Detail specification for 850-nm laser-optimized, 50-μm core 2 diameter/125-μm cladding diameter class Ia graded-index multimode 3 optical fibers suitable for manufacturing OM4 cabled optical fiber,” Draft Standard). In FIG. 3, we plot zero-dispersion slope production data. We conclude that the dispersion slope can be reduced to a value below 0.10 ps/nm²·km. Although 0.10 ps/nm²·km offers some dispersion improvement, to achieve better performance it is proposed that a zero-dispersion slope which is ≦0.10 ps/nm²·km, and preferably which is ≦0.095 ps/nm²·km, is used. Since 80% of the fiber manufactured by this supplier meets this more stringent S₀ requirement, an additional benefit can be realized by sorting MMF for this reduced value (with little additional cost). Sorting will assure improved performance and help differentiate from competitive products. We note that all manufactured fiber is tested and sorted into OM3 and OM4 fiber types based on bandwidth measurements. Sorting for reduced zero-dispersion slope would add cost, but this should be justified considering that the goal is producing a premium product, and that alternative solutions would be more expensive.

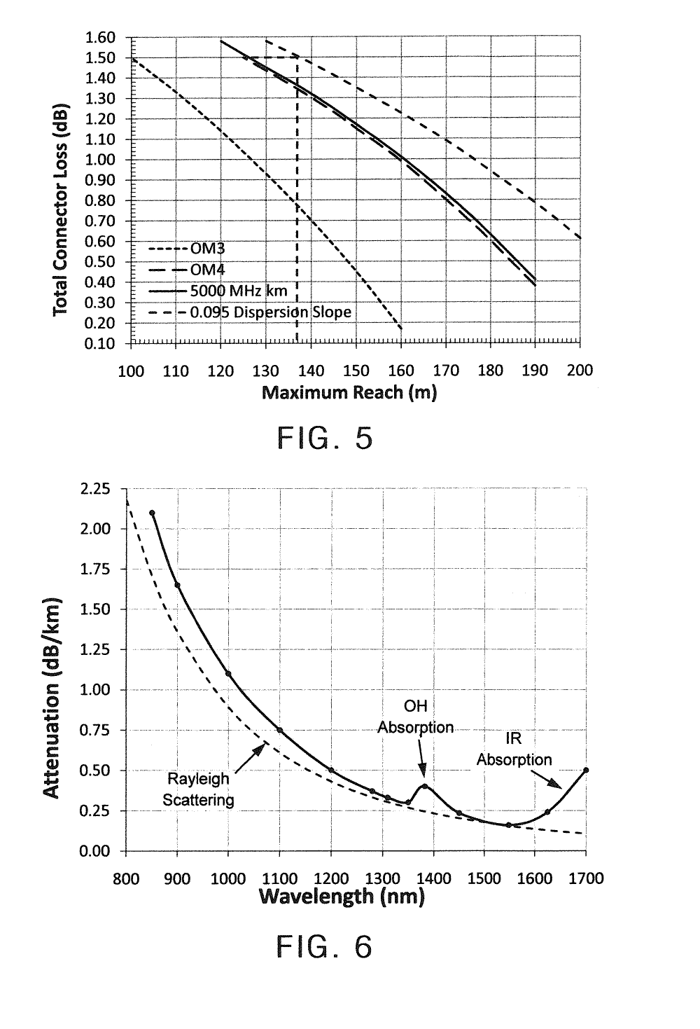

In FIG. 4, we plot the calculated increase in margin due to reduced zero-dispersion slope, as predicted by the IEEE Ethernet Link Model. This increase in margin can be used for additional reach as shown in FIG. 5. Based on this analysis, the optical channel reach is extended from 125 m to 137 m, an additional 9.6% increase in distance.

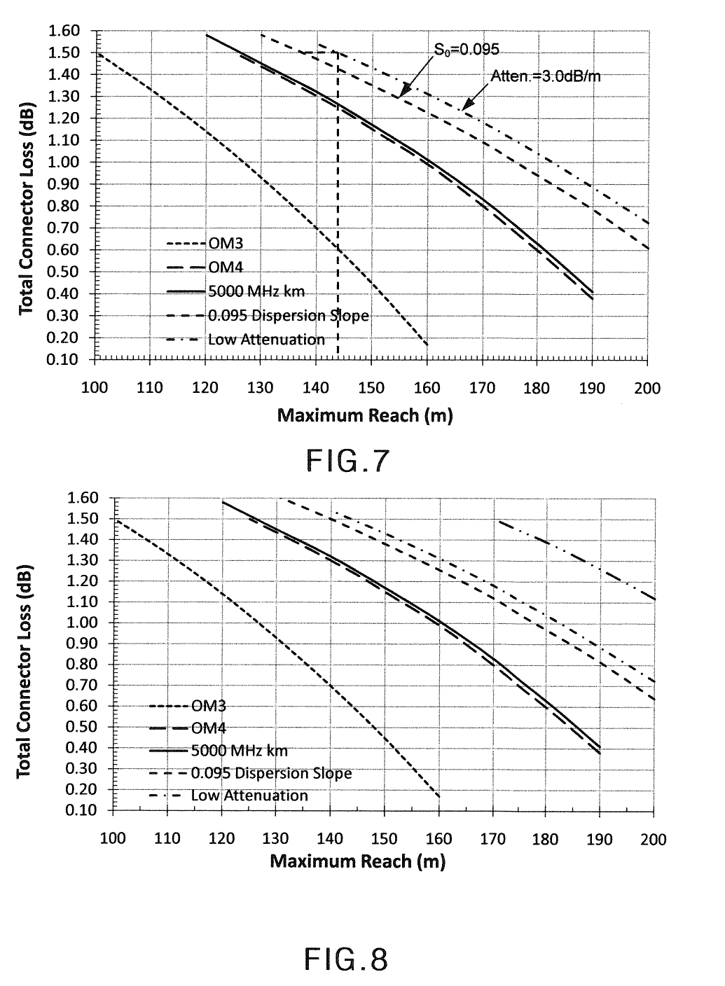

Reducing cable attenuation is another method for realizing an improved-performance MMF. Signal degradation in an optical fiber is also the result of optical attenuation. In FIG. 6, we plot the measured and theoretical attenuation curves for optical fiber. We present these curves to illustrate that optical glass used in the manufacture of fiber is highly purified and therefore, the attenuation is close to the theoretical limit. However, several reductions in attenuation can still be made. The maximum fiber attenuation specified in TIA-492AAAD, is 2.5 dB/km, and considered a conservative number, which can be slightly reduced to 2.3 dB/km. More importantly, the attenuation of optical fiber significantly increases as a result of the cabling process. Due to induced stress and micro-bending of fiber when cabled, the attenuation coefficient increases by approximately 50%. As a result, the specified maximum cable attenuation is 3.5 dB/km at the operating wavelength of 850 nm (Sec TIA-568-C.3 (Revision of TIA-568-B.3), “Optical Fiber Cabling Components Standard,” June 2008). Therefore, improving the cable design, will lead to lower attenuation. We believe a reduced cable attenuation of ≦3.0 dB/km is achievable, which would° provide additional optical margin. In FIG. 7, we plot the predicted channel reach obtained by reducing the attenuation coefficient to 3.0 dB/km.

The reduction in cable attenuation provides an additional 5% increase in reach for a maximum of 145 m. This extended reach, although seemingly small, would serve more than 30% of the unsupported links beyond 125 m.

Finally, we can obtain significantly more margin by employing chromatic dispersion compensation as described in U.S. patent application Ser. No. 12/858,210, which can be quantified by means of a shift metric described in U.S. patent application Ser. No. 12/797,328. Chromatic dispersion occurs since laser transmitters emit light having a variety of wavelengths, and not just one wavelength. Once this light enters the MMF, this light of varying wavelength causes chromatic dispersion to occur within the MMF which can either increase or decrease any modal dispersion present in the MMF. Since modal dispersion can be reduced by compensating for chromatic dispersion, we can reduce the chromatic dispersion penalty in the IEEE Ethernet Link Model (to first order) and predict a theoretical maximum reach if we know the wavelength distribution of a particular laser transmitter. Based on this assumption, the IEEE Ethernet Link Model predicts a 215 m maximum reach for this new improved MMF, see FIG. 8. It is important to note that the IEEE link model is considered a conservative estimate. However, due to process variation the refractive index profile, compensating for chromatic dispersion would be less than perfect and therefore, this estimate might be a good first-order approximation. The actual maximum reach will be determined by research.

Although chromatic dispersion compensation provides the largest increase in margin and hence reach, this invention proposes an overall improvement of reach for OM4 fiber, and therefore, the contributions of various parameters are taken into account. The total increase in reach for this new MMF is potentially 90 m (125 m to 215 m), where the reduction in zero-dispersion slope and attenuation account for 28% of the total added reach. This new MMF will support virtually all of the channel links within the data center in next generation high-speed networks.

While particular aspects of the present subject'matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. Accordingly, the invention is not to be restricted except in light of the appended claims and their equivalents.

1. A multimode fiber optic cable comprising:
a refractive index profile which is designed to compensate for a radially dependent wavelength distribution of laser launch modes coupled into the multimode fiber optic cable in order to minimize modal dispersion within the multimode fiber optic cable; and
wherein the multimode fiber optic cable has a zero-dispersion slope of equal to or less than 0.10 ps/nm²·km.

2. The multimode fiber optic cable of claim 1, wherein the multimode fiber optic cable has been presorted to have a zero-dispersion slope which is less than or equal to 0.095 ps/nm²·km.

3. The multimode fiber optic cable of claim 1, wherein the multimode fiber optic cable has a cable attenuation which is less than or equal to 3.0 dB/km.

4. The multimode fiber optic cable of claim 1, wherein the multimode fiber optic cable has a negative shift metric in a differential mode delay measurement profile.

5. A method for designing an improved multimode fiber optic cable having extended channel reach comprising:
determining a radially dependent wavelength distribution for light emitted from a laser transmitter; and
providing an improved refractive index profile for the improved multimode fiber optic cable which reduces modal dispersion within the improved multimode fiber optic cable based upon knowledge of the radially dependent wavelength distribution of light emitted from the laser transmitter.

6. The method of claim 5 further comprising selecting improved multimode fiber optic cables which have a zero-dispersion slope of equal to or less than 0.10 ps/nm²·km.

7. The method of claim 5 further comprising selecting improved multimode fiber optic cables which have been presorted to have a zero-dispersion slope which is less than or equal to 0.095 ps/nm²·km.

8. The method of claim 5 further comprising designing the improved multimode fiber optic cable to have a cable attenuation which is less than or equal to 3.0 dB/km.

9. The method of claim 5 further comprising designing the improved multimode fiber optic cable to have a negative shift metric in a differential mode delay measurement profile.
